(19) United States
(12) Patent Application Publication
(10) Pub. No.: US 2025/0267507 A1
(43) Pub. Date: Aug. 21, 2025

(54) COMMUNICATION DEVICE, COMMUNICATION NETWORK SYSTEM, AND COMMUNICATION METHOD

(71) Applicant: TOYOTA JIDOSHA KABUSHIKI KAISHA, Toyotya-sh (JP)

(72) Inventor: Shinnosuke SUGAWARA, Toyotya-shi (JP)

(73) Assignee: TOYOTA JIDOSHA KABUSHIKI KAISHA, Toyotya-sh (JP)

(21) Appl. No.: 19/033,499

(22) Filed: Jan. 22, 2025

(30) Foreign Application Priority Data
Feb. 16, 2024 (JP) 2024-022076

(51) Int. Cl. H04W 28/04

(52) U.S. Cl. CPC H04W 28/04

(57) ABSTRACT

A transmission device, which is a communication device that transmits a message, transmits a message including a freshness value composed of a high-order digit counted up every time a message is started and a low-order digit counted up every time a message is transmitted. The reception device, which is a communication device that receives a message, receives the message on condition that the freshness value included in the received message is larger than the stored freshness value. The transmission device transmits the first message including the freshness value of the maximum value when the reading of the high-order digit fails at the time of activation. Then, the transmission device transmits, after the first message, the second message including the freshness value equal to or greater than the minimum value and less than the maximum value.

### CROSS-REFERENCE TO RELATED APPLICATION

This application claims priority to Japanese Patent Application No. 2024-022076 filed on Feb. 16, 2024, incorporated herein by reference in its entirety.

### BACKGROUND

### 1. Technical Field

The present disclosure relates to a communication device, a communication network system, and a communication method.

### 2. Description of Related Art

Japanese Unexamined Patent Application Publication No. 2012-169829 (JP 2012-169829 A) describes a communication network system. The communication network system includes a plurality of communication devices. In the communication network system, the communication devices exchange messages with each other.

In the message exchange between the communication devices, the communication device that transmits the message transmits the message including a freshness value. The freshness value includes a high-order digit that is counted up every time the communication device is activated, and a low-order digit that is counted up every time a message is transmitted.

In the message exchange between the communication devices, the communication device that receives the message from another communication device checks the freshness value included in the message. The communication device accepts the message when the received freshness value is larger than the freshness value included in the message that has been accepted before receiving the message.

### SUMMARY

In order to count up the high-order digit of the freshness value, the communication device reads, at the time of activation, the high-order digit stored at the time of shutdown. At this time, the communication device may fail to read the high-order digit. In this case, the communication device cannot assign an appropriate freshness value to the message. Therefore, the communication device cannot transmit a message including an appropriate freshness value to another communication device while the communication device fails to read the high-order digit.

A communication device according to a first aspect of the present disclosure is a transmission-side communication device that transmits a message in a communication network system.

The communication network system includes a plurality of communication devices. In exchange of a message between the communication devices in the communication network system,

the transmission-side communication device transmits the message including a predetermined range of a freshness value including a high-order digit that is counted up every time the transmission-side communication device is activated and a low-order digit that is counted up every time the message is transmitted.
In the exchange of the message between the communication devices in the communication network system,
a reception-side communication device that receives the message accepts the message under a condition that the freshness value included in the received message is larger than the freshness value that is stored.
The reception-side communication device stores the freshness value included in the accepted message.
The reception-side communication device
accepts, when the message including the freshness value that is a maximum value is received, the message including the freshness value that is smaller than the maximum value and received after the message including the freshness value that is the maximum value.
The transmission-side communication device includes
a processing device.
When the transmission-side communication device fails to read the high-order digit at a time of activation,
the processing device transmits a first message including the freshness value that is the maximum value.
The processing device transmits, after the first message, a second message including the freshness value that is equal to or larger than a minimum value and smaller than the maximum value.

A communication network system according to a second aspect of the present disclosure includes

a plurality of communication devices.
In exchange of a message between the communication devices in the communication network system,
a transmission-side communication device that transmits the message transmits the message including a predetermined range of a freshness value including a high-order digit that is counted up every time the transmission-side communication device is activated and a low-order digit that is counted up every time the message is transmitted.
In the exchange of the message between the communication devices in the communication network system,
a reception-side communication device that receives the message accepts the message under a condition that the freshness value included in the received message is larger than the freshness value that is stored.
The reception-side communication device stores the freshness value included in the accepted message.
The reception-side communication device accepts, when the message including the freshness value that is a maximum value is received, the message including the freshness value that is smaller than the maximum value and received after the message including the freshness value that is the maximum value.
In the communication network system, the transmission-side communication device transmits, when failing to read the high-order digit at a time of activation, a first message including the freshness value that is the maximum value.
In the communication network system, the transmission-side communication device transmits, after the first message, a second message including the freshness value that is equal to or larger than a minimum value and smaller than the maximum value.

A communication method according to a third aspect of the present disclosure is applied to a transmission-side communication device that transmits a message in a communication network system. The communication network system includes a plurality of communication devices.

In exchange of a message between the communication devices in the communication network system,
the transmission-side communication device
transmits the message including a predetermined range of a freshness value including a high-order digit that is counted up every time the transmission-side communication device is activated and a low-order digit that is counted up every time the message is transmitted.
In the exchange of the message between the communication devices in the communication network system,
a reception-side communication device that receives the message
accepts the message under a condition that the freshness value included in the received message is larger than the freshness value that is stored.
The reception-side communication device stores the freshness value included in the accepted message.
The reception-side communication device accepts, when the message including the freshness value that is a maximum value is received, the message including the freshness value that is smaller than the maximum value and received after the message including the freshness value that is the maximum value.
The communication method includes causing the transmission-side communication device to transmit, when failing to read the high-order digit at a time of activation, a first message including the freshness value that is the maximum value. The communication method includes causing the transmission-side communication device to transmit, after the first message, a second message including the freshness value that is equal to or larger than a minimum value and smaller than the maximum value.

With the communication device, the communication network system, and the communication method, it is possible to transmit the message including the appropriate freshness value even when failing to read the high-order digit of the freshness value.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a configuration of a communication network system including a communication device according to an embodiment;

FIG. 2 is an explanatory diagram illustrating a freshness value included in a message transmitted by the communication device according to the embodiment;

FIG. 3 is a sequence diagram illustrating an aspect of communication in the communication network system when the communication device of the embodiment succeeds in reading the high-order digit of the freshness value; and

FIG. 4 is a sequence diagram illustrating an aspect of communication in the communication network system in a case where the communication device of the embodiment fails to read the high-order digit of the freshness value.

### DETAILED DESCRIPTION OF EMBODIMENTS

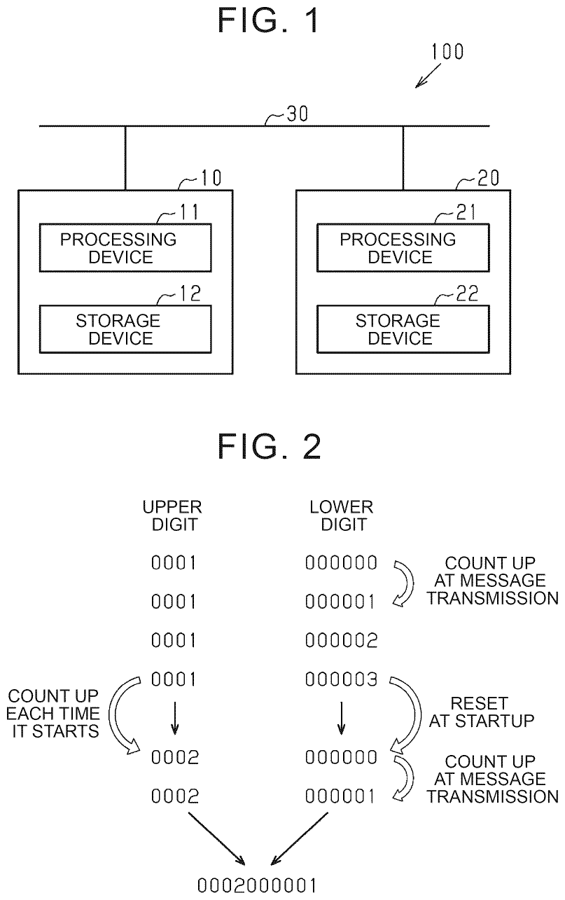

Hereinafter, an embodiment of a communication device will be described with reference to FIG. 1 to FIG. 4.

A configuration of the communication network system 100 will be described. As illustrated in FIG. 1, the communication network system 100 includes a plurality of communication devices. Specifically, the communication network system 100 includes a transmission device 10 and a reception device 20 as communication devices. The communication network system 100 is applied to, for example, a vehicle. The transmission device 10 and the reception device 20 in the communication network system 100 are, for example, electronic control devices provided in a vehicle.

As illustrated in FIG. 1, the transmission device 10 and the reception device 20 are connected to each other via a communication bus 30. The transmission device 10 transmits a message to the reception device 20 through the communication bus 30. That is, the transmission device 10 is a transmission-side communication device that transmits a message in the exchange of messages between the communication devices. On the other hand, the reception device 20 is a communication device on the reception side that receives a message in the exchange of messages between the communication devices.

As illustrated in FIG. 1, the transmission device 10 includes a processing device 11 and a storage device 12. A program is stored in the storage device 12. The processing device 11 executes programs stored in the storage device 12 to execute various processes. The processing device 11 includes a processor.

As illustrated in FIG. 1, the reception device 20 includes a processing device 21 and a storage device 22. A program is stored in the storage device 22. The processing device 21 executes programs stored in the storage device 22 to execute various processes. The processing device 21 includes a processor.

### Summary of Freshness Values

The transmission device 10 transmits a message including the freshness value to the reception device 20. FIG. 2 illustrates a freshness value included in a message transmitted by the transmission device 10.

As illustrated in FIG. 2, the freshness value includes a high-order digit and a low-order digit.

As illustrated in FIG. 2, the transmission device 10 counts up the upper digit of the freshness value at the time of activation. That is, the upper digit of the freshness value is counted up every time the transmission device 10 is activated.

As illustrated in FIG. 2, the transmission device 10 counts up the lower digit of the freshness value at the time of transmission of the message. That is, the lower digit of the freshness value is counted up every time the transmission device 10 transmits a message.

As illustrated in FIG. 2, the transmission device 10 resets the lower digit of the freshness value at the time of activation. That is, the lower digit of the freshness value is reset each time the transmission device 10 is activated.

The freshness value is formed by combining the upper digit and the lower digit. As shown in the lower part of FIG. 2, for example, when the upper digit is “0002” and the lower digit is “000001”, the freshness value included in the message is “0002000001”.

The higher the upper digit, the higher the freshness value. When the upper digits are the same, the higher the lower digit, the higher the freshness value. In the communication network system 100, the upper digit has a minimum value of “0001” and a maximum value of “9999”. In the communication network system 100, the lower digit has a minimum value of “000000” and a maximum value of “999999”. Therefore, in the communication network system 100, the minimum value of the freshness value is “0001000000”. In the communication network system 100, the maximum value of the freshness value is “9999999999”. Thus, there is a predetermined range of freshness values. Flow of Communication When Transmission Device 10 Succeeds in Reading High-Order Digit

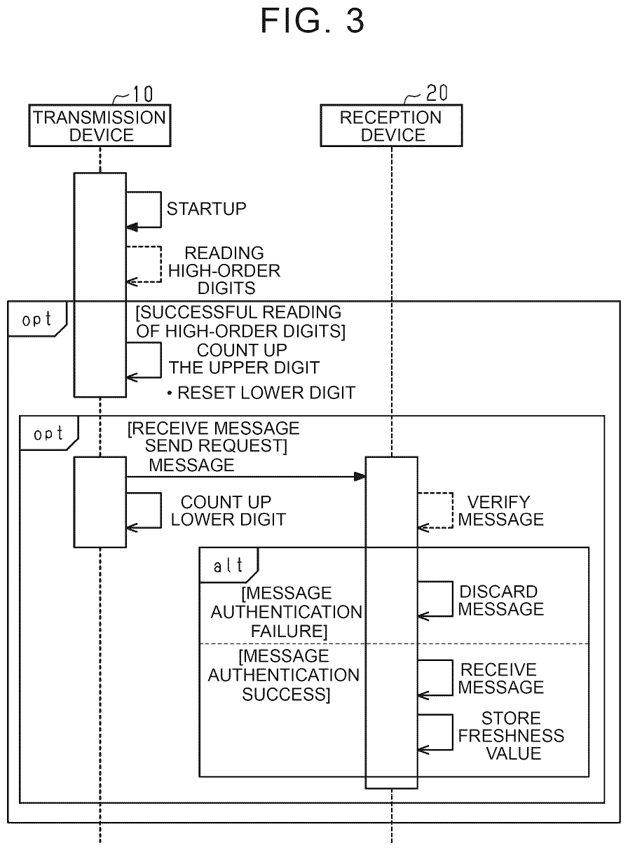

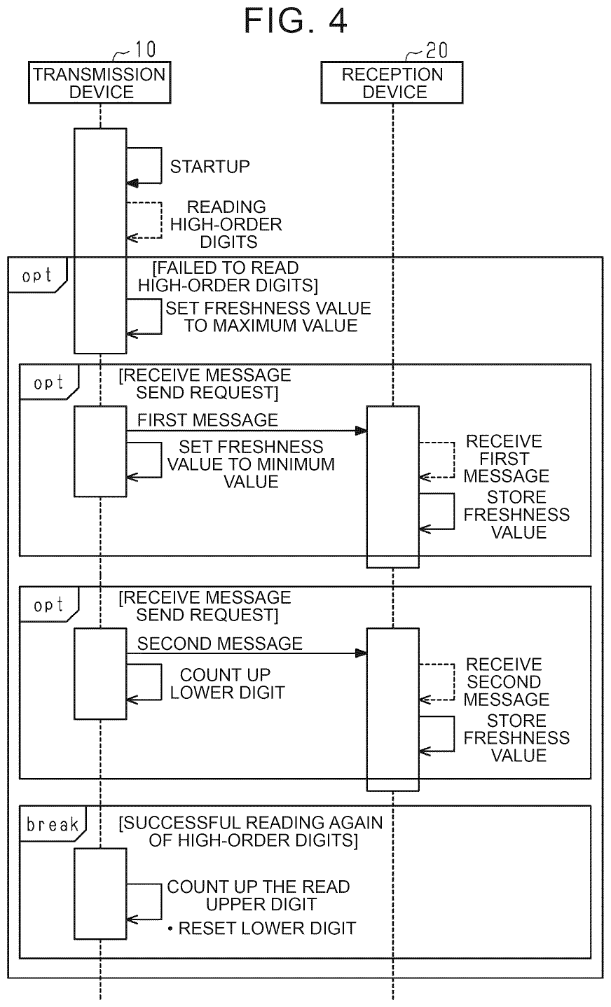

FIG. 3 and FIG. 4 illustrate aspects of communication in a communication network system 100. In FIG. 3 and FIG. 4, the processing device 11 executes the processing executed by the transmission device 10. In FIG. 3 and FIG. 4, the processing performed by the reception device 20 is performed by the processing device 21.

As described above, the upper digit of the freshness value is counted up every time it is started. Therefore, when stopping the operation, the transmission device 10 stores the high-order digit of the freshness value included in the message transmitted by itself in the storage device 12. Then, the transmission device 10 reads the high-order digit of the freshness value stored in the storage device 12 at the time of activation. At this time, the transmission device 10 may fail to read the high-order digit of the freshness value. FIG. 3 shows a specific example of the mode of communication in the communication network system 100 when the transmission device 10 succeeds in reading the high-order digit of the freshness value. On the other hand, FIG. 4 shows a specific example of the mode of communication in the communication network system 100 when the transmission device 10 fails to read the high-order digit of the freshness value.

First, with reference to FIG. 3, an aspect of communication in the communication network system 100 in a case where the transmission device 10 succeeds in reading the high-order digit of the freshness value will be described.

As shown in the upper part of FIG. 3, the transmission device 10 reads the upper digit of the freshness value after the activation. The transmission device 10 is activated, for example, when the ignition switch of the vehicle is turned on.

As illustrated in the upper part of FIG. 3, when the reading of the high-order digit is successful, the transmission device 10 counts up the high-order digit of the freshness value. At this time, the transmission device 10 counts up the high-order digit that has been successfully read in the manner described with reference to FIG. 2. On the other hand, the transmission device 10 resets the lower digit of the freshness value. In this way, when the reading of the high-order digit is successful, the freshness value is set to a value consisting of the high-order digit counted up and the low-order digit reset to the minimum value.

As illustrated in the lower part of FIG. 3, the transmission device 10 transmits a message when receiving a message transmission request. For example, the transmission device 10 transmits a message when it receives a message requesting transmission of a message from the reception device 20. In the lower part of FIG. 3, the transmission device 10 transmits a message including the freshness value set in the upper part of FIG. 3.

As illustrated in the lower part of FIG. 3, the transmission device 10 counts up the lower digit of the freshness value after transmitting the message. At this time, the transmission device 10 counts up the lower digit of the freshness value in the manner described with reference to FIG. 2.

As illustrated in the lower part of FIG. 3, the reception device 20 that has received the message verifies the received message. The reception device 20 verifies the integrity of the received message by verifying the message. That is, the reception device 20 confirms whether or not the message is correctly transmitted from the transmission device 10, whether or not the message is affected by a cyber attack or the like, and the like through the verification of the message.

When the reception device 20 confirms the integrity of the received message through the verification of the message, the authentication of the message is successful. On the other hand, when the integrity of the received message cannot be confirmed through the verification of the message, the reception device 20 fails to authenticate the message.

The reception device 20 verifies the message based on the freshness value included in the received message. As will be described later, when the received message is successfully authenticated, the reception device 20 stores the freshness value included in the message in the storage device 22. The reception device 20 verifies the message by comparing the magnitude of the freshness value included in the received message with the freshness value stored in the storage device 22.

For example, the reception device 20 stores the freshness value included in the latest message in the message that has been successfully authenticated in the storage device 22. Then, when the freshness value included in the received message is larger than the freshness value stored in the storage device 22, the reception device 20 succeeds in authenticating the message.

In a case where the transmission device 10 continuously transmits a message, the reception device 20 may receive a message in an order different from the order in which the transmission device 10 transmitted the message. In such a situation, the reception device 20 may store the freshness value included in the plurality of messages that have been successfully authenticated in the storage device 22.

For example, the reception device 20 stores, in the storage device 22, a freshness value included in five messages counted from the latest message for the message that has been successfully authenticated. The freshness value stored in the reception device 20 is not limited to five. Thereafter, the reception device 20 compares the minimum freshness value stored in the storage device 22 with the freshness value included in the received message. If the freshness value included in the received message is greater than the minimum freshness value, the reception device 20 checks whether the freshness value included in the received message is the same as any freshness value stored in the storage device 22. That is, the reception device 20 checks whether the freshness value included in the received message is the same as the freshness value included in the message that has been successfully authenticated in the past. When the reception device 20 confirms that the freshness value included in the received message is different from the freshness value included in the message that has been successfully authenticated in the past, the message is successfully authenticated.

As illustrated in the lower part of FIG. 3, when authentication of the received message fails, the reception device 20 rejects the message. That is, the reception device 20 discards the message without accepting the message.

As illustrated in the lower part of FIG. 3, when the received message is successfully authenticated, the reception device 20 receives the message. Thereafter, the freshness value included in the received message is stored in the storage device 22.

In this way, the reception device 20 receives the message on condition that the freshness value included in the received message is larger than the stored freshness value. Then, the reception device 20 stores the freshness value included in the received message.

Hereinafter, in FIG. 3, when a message transmission request is received, the processing illustrated in the lower part of FIG. 3 is executed. That is, the transmission device 10 counts up the lower digit of the freshness value after transmitting the message every time the transmission request of the message is received. Then, the reception device 20 that has received the message verifies the message.

When the freshness value of the maximum value is stored, and the freshness value included in the next received message is less than the maximum value, the reception device 20 receives the message. That is, when receiving the message including the freshness value of the maximum value, the reception device 20 receives the message including the freshness value less than the maximum value received after the message.

### Communication Flow when Transmission Device 10 Fails to Read High-Order Digits

Next, with reference to FIG. 4, an aspect of communication in the communication network system 100 in a case where the transmission device 10 fails to read the high-order digit of the freshness value will be described.

In the upper part of FIG. 4, the mode of reading the upper digit of the freshness value after the transmission device 10 is activated is the same as the upper part of FIG. 3.

As illustrated in the upper part of FIG. 4, in a case where the reading of the upper digit fails, the transmission device 10 sets the freshness value to the maximum value.

As illustrated in the middle part of FIG. 4, when receiving a message transmission request, the transmission device 10 transmits a first message. The first message is a message transmitted by the transmission device 10 after the transmission device 10 fails to read the high-order digit. At this time, the message transmitted by the transmission device 10 includes the freshness value of the maximum value set in the upper stage of FIG. 4. As described above, the processing device 11 of the transmission device 10 executes the transmission of the first message including the freshness value of the maximum value when the reading of the high-order digit fails at the time of activation.

As illustrated in the middle part of FIG. 4, the reception device 20 that has received the first message receives the first message. As described above, the reception device 20 receives the message when the freshness value included in the received message is larger than the freshness value stored in the reception device. The freshness value of the maximum value easily satisfies such a condition. Note that, in order to ensure that the reception device 20 receives the first message, the reception device 20 may adopt a configuration in which, when a message including a maximum freshness value is received, the message is received without performing verification.

As illustrated in the middle part of FIG. 4, the reception device 20 that has received the first message stores the freshness value included in the first message in the storage device 22.

As illustrated in the middle part of FIG. 4, after transmitting the first message, the transmission device 10 sets the freshness value to the minimum value.

As illustrated in the lower part of FIG. 4, after transmitting the first message, the transmission device 10 transmits the second message when receiving the message transmission request. The second message is a message transmitted after the transmission device 10 transmits the first message. The processing device 11 of the transmission device 10 performs transmitting, after the first message, a second message including a freshness value that is greater than or equal to the minimum value and less than the maximum value.

The second message includes a freshness value that is greater than or equal to the minimum value and less than the maximum value. As described above, when receiving the message including the maximum freshness value, the reception device 20 receives the message including the freshness value less than the maximum value received after the message. Therefore, the reception device 20 that has received the first message can successfully authenticate the second message. In the present embodiment, the second message transmitted by the transmission device 10 includes the freshness value of the minimum value set in the middle stage of FIG. 4. That is, when transmitting the second message, the processing device 11 of the transmission device 10 performs transmission of the message including the freshness value of the minimum value.

As illustrated in the lower part of FIG. 4, the reception device 20 that has received the second message receives the second message. Thereafter, the reception device 20 stores the freshness value included in the second message.

As illustrated in the lower part of FIG. 4, after transmitting the second message, the transmission device 10 counts up the lower digit of the freshness value. At this time, the transmission device 10 counts up the lower digit of the freshness value in the manner described with reference to FIG. 2.

The reception device 20 stores the freshness value included in the second message, and verifies the message to be received next to the second message based on the freshness value included in the second message. That is, after transmitting the second message, the transmission device 10 can cause the reception device 20 to receive the transmitted message by counting up the lower digit of the freshness value each time the message is transmitted. In this way, even if the reading of the upper digit fails, the transmission device 10 can reset the criterion of the message authentication of the reception device 20 by transmitting the first message and the second message.

The transmission device 10 includes the freshness value of the minimum value in the second message. Therefore, the transmission device 10 can reset the freshness value to the minimum value by the second message and restart the counting. As a result, the transmission device 10 can resume the transmission of the message including the freshness value for which the authentication is successful.

After the reading of the high-order digit of the freshness value fails, the transmission device 10 periodically attempts to read the high-order digit again. As illustrated in the lower part of FIG. 4, when the high-order digit of the freshness value is successfully read again, the transmission device 10 sets the freshness value to a value consisting of the high-order digit counted up by one from the read value and the low-order digit reset to the minimum value. Thereafter, the transmission device 10 transmits the message while counting up the freshness value set after the successful reading.

As described above, the processing device 11 of the transmission device 10 performs the re-reading of the high-order digit after the reading of the high-order digit fails. The processing device 11 of the transmission device 10 causes the read high-order digit to be counted up when the reading of the high-order digit succeeds, and sets a freshness value including the counted high-order digit and the low-order digit of the minimum value.

Thus, when the reading of the higher-order digit succeeds by the re-reading, the communication device can resume the counting while continuing the counting of the higher-order digit before the reading of the higher-order digit fails. The upper digit of the freshness value is information indicating the number of times the transmission device 10 is activated. Therefore, the transmission device 10 does not need to lose such information.

### Operations of Present Embodiment

The reception device 20, which is the communication device of the reception side, receives the message when the freshness value included in the received message is larger than the freshness value stored in the reception side. When the freshness value is the maximum value for both the high-order digit and the low-order digit, such a condition is easily satisfied.

The transmission device 10, which is the communication device on the transmission side, sets the freshness value of the first message to the maximum value when the reading of the high-order digit of the freshness value fails at the time of activation. Accordingly, the transmission device 10 can cause the reception device 20 to receive the first message even if the reading of the high-order digit of the freshness value fails at the time of activation.

In addition, in a case where a message having a maximum freshness value is received, the reception device 20 stores the freshness value for the next message to be received, after receiving the message even when the freshness value is smaller than the maximum value. As a result, the reference of the freshness value in the reception device 20 is reset.

The transmission device 10 sets the freshness value of the second message to a value equal to or greater than the minimum value and less than the maximum value. Thereafter, the transmission device 10 can send a message from the freshness value included in the second message as a starting point while counting up the freshness value.

### Effects of Present Embodiment

(1) The transmission device 10, which is a communication device on the transmission side, can transmit a message including an appropriate freshness value even when reading of a high-order digit of the freshness value fails.
(2) When transmitting the second message, the processing device 11 of the transmission device 10 transmits the message including the freshness value of the minimum value. The transmission device 10 sets the minimum value as the freshness value included in the second message. That is, the transmission device 10 uses a value that is the most deviated from the maximum value as the freshness value included in the second message. As a result, the transmission device 10 can reset the freshness value included in the message to be transmitted to the minimum value by the second message and restart the counting.
(3) The processing device 11 of the transmission device 10 performs the re-reading of the high-order digit after the reading of the high-order digit fails. The processing device 11 of the transmission device 10, when the re-reading of the high-order digit succeeds, counts up the read high-order digit and performs setting of a freshness value including the high-order digit counted up and the low-order digit of the minimum value.

When the re-reading of the high-order digit succeeds, the transmission device 10 sets the freshness value using the value that has been successfully read. Thus, when the reading of the higher-order digit succeeds by the re-reading, the transmission device 10 can resume the counting while continuing the counting of the higher-order digit until the reading of the higher-order digit fails.
(4) The communication network system 100 includes a plurality of communication devices. In the message exchange between the communication devices, the transmission device 10, which is the communication device on the transmission side that transmits the message, transmits a message including a freshness value in a predetermined range configured by the upper digit and the lower digit. The upper digit is counted up every time the transmission device 10 is activated. The lower digit is counted up every time the transmission device 10 transmits a message. In the message exchange between the communication devices, the reception device 20, which is the communication device of the reception side that receives the message, receives the message on condition that the freshness value included in the received message is larger than the stored freshness value. In addition, the reception device 20 stores the freshness value included in the received message. Then, when receiving the message including the freshness value of the maximum value, the reception device 20 receives the message including the freshness value less than the maximum value received after the message. In the communication network system 100, the transmission device 10 transmits a first message including a maximum freshness value when reading of a high-order digit fails at the time of activation. Then, the transmission device 10 transmits, after the first message, the second message including the freshness value that is equal to or greater than the minimum value and less than the maximum value.

In the communication network system 100, the transmission device 10 sets the freshness value of the first message to the maximum value when the reading of the high-order digit of the freshness value fails at the time of startup. Thereafter, in the communication network system 100, the transmission device 10 sets the freshness value of the second message to a value equal to or greater than the minimum value and less than the maximum value. Thereafter, the transmission device 10 can send a message from the freshness value included in the second message as a starting point while counting up the freshness value. In this way, the communication network system 100 can transmit a message including an appropriate freshness value even when the communication device on the transmitting side fails to read the high-order digit of the freshness value.
(5) The communication method is applied to the transmission device 10, which is a communication device on the transmission side that transmits a message, in the exchange of messages between the communication devices in the communication network system 100. The communication network system 100 includes a plurality of communication devices. In the message exchange between the communication devices, the transmission device 10 transmits a message including a freshness value in a predetermined range configured by a high-order digit counted up every time the communication device starts up and a low-order digit counted up every time the communication device transmits the message. In the message exchange between the communication devices, the reception device 20, which is the communication device of the reception side that receives the message, receives the message on condition that the freshness value included in the received message is larger than the stored freshness value. In addition, the reception device 20 stores the freshness value included in the received message. Then, when receiving the message including the freshness value of the maximum value, the reception device 20 receives the message including the freshness value less than the maximum value received after the message. The communication method includes the step of transmitting the first message including the freshness value of the maximum value when the transmission device 10 fails to read the high-order digit at the time of activation. The communication method includes a step in which the transmission device 10 transmits, after the first message, a second message including a freshness value equal to or greater than a minimum value and less than a maximum value.

In the communication method, when the transmission device 10 fails to read the high-order digit of the freshness value at the time of activation, the transmission device 10 sets the freshness value of the first message to the maximum value. Thereafter, the communication method causes the transmission device 10 to set the freshness value of the second message to a value equal to or greater than the minimum value and less than the maximum value. Thereafter, the transmission device 10 can send a message from the freshness value included in the second message as a starting point while counting up the freshness value. In this way, the communication method can transmit a message including an appropriate freshness value even when the communication device on the transmitting side fails to read the upper digit of the freshness value.

### Modifications

The present embodiment can be realized with the following modifications. The present embodiment and the following modifications can be combined with each other within a technically consistent range to be realized.
In the above-described embodiment, two communication devices, a transmission device 10 and a reception device 20, are connected to the communication network system 100. The mode of connection of the communication device in the communication network system 100 is not limited to the above-described embodiment. That is, the topology of the communication device in the communication network system 100 is not limited to the above-described embodiment. The number of communication buses and the number of connected communication devices in the communication network system 100 are not limited to the above-described embodiments.

In the above-described embodiment, the communication device in the communication network system 100 is connected through the communication bus 30. Meanwhile, the communication device in the communication network system 100 may be wirelessly connected.

In the above-described embodiment, the transmission device 10 transmits a message including the freshness value of the minimum value as the second message. On the other hand, the freshness value included in the second message transmitted by the transmission device 10 may be greater than the minimum value and less than the maximum value.

What is claimed is:

1. A communication device in a communication network system including a plurality of communication devices configured such that in exchange of a message between the communication devices,
a transmission-side communication device that transmits the message transmits the message including a predetermined range of a freshness value including a high-order digit that is counted up every time the transmission-side communication device is activated and a low-order digit that is counted up every time the message is transmitted, and
a reception-side communication device that receives the message
accepts the message under a condition that the freshness value included in the received message is larger than the freshness value that is stored,
stores the freshness value included in the accepted message, and
when the message including the freshness value that is a maximum value is received, accepts the message including the freshness value that is smaller than the maximum value and received after the message including the freshness value that is the maximum value,
the communication device being the transmission-side communication device comprising a processing device, wherein
the processing device is configured to, when failing to read the high-order digit at a time of activation,
transmit a first message including the freshness value that is the maximum value, and
transmit, after the first message, a second message including the freshness value that is equal to or larger than a minimum value and smaller than the maximum value.

2. The communication device according to claim 1, wherein the processing device is configured to when transmitting the second message, transmit the message including the freshness value that is the minimum value.

3. The communication device according to claim 1, wherein the processing device is configured to read the high-order digit again after failure to read the high-order digit, and when the high-order digit is successfully read again, count up the read high-order digit and set the freshness value including the high-order digit that has been counted up and the low-order digit that is a minimum value.

4. A communication network system comprising a plurality of communication devices configured such that in exchange of a message between the communication devices,
a transmission-side communication device that transmits the message transmits the message including a predetermined range of a freshness value including a high-order digit that is counted up every time the transmission-side communication device is activated and a low-order digit that is counted up every time the message is transmitted, and
a reception-side communication device that receives the message
accepts the message under a condition that the freshness value included in the received message is larger than the freshness value that is stored,
stores the freshness value included in the accepted message, and
when the message including the freshness value that is a maximum value is received, accepts the message including the freshness value that is smaller than the maximum value and received after the message including the freshness value that is the maximum value, wherein
the transmission-side communication device is configured to
when failing to read the high-order digit at a time of activation, transmit a first message including the freshness value that is the maximum value, and
transmit, after the first message, a second message including the freshness value that is equal to or larger than a minimum value and smaller than the maximum value.

5. A communication method in a communication network system including a plurality of communication devices configured such that in exchange of a message between the communication devices,
a transmission-side communication device that transmits the message transmits the message including a predetermined range of a freshness value including a high-order digit that is counted up every time the transmission-side communication device is activated and a low-order digit that is counted up every time the message is transmitted, and
a reception-side communication device that receives the message
accepts the message under a condition that the freshness value included in the received message is larger than the freshness value that is stored,
stores the freshness value included in the accepted message, and
when the message including the freshness value that is a maximum value is received, accepts the message including the freshness value that is smaller than the maximum value and received after the message including the freshness value that is the maximum value,
the communication method being applied to the transmission-side communication device, the communication method comprising causing the transmission-side communication device to, when failing to read the high-order digit at a time of activation,
transmit a first message including the freshness value that is the maximum value, and
transmit, after the first message, a second message including the freshness value that is equal to or larger than a minimum value and smaller than the maximum value.
